(19) United States
(12) Patent Application Publication
(10) Pub. No.: US 2025/0075081 A1
(43) Pub. Date: Mar. 6, 2025

(54) CARBON BLACK AND APPLICATION THEREOF

(71) Applicant: Linyuan Advanced Materials Technology Co., Ltd., Kaohsiung City (TW)

(72) Inventors: Jheng-Guang LI, Kaohsiung City (TW); Pu-Wei SHEN, Kaohsiung City (TW); Ya-Syuan LIN, Kaohsiung City (TW)

(21) Appl. No.: 18/815,351

(22) Filed: Aug. 26, 2024

(30) Foreign Application Priority Data
Aug. 29, 2023 (TW) 112132586

(51) Int. Cl. C09C 1/48

(52) U.S. Cl. CPC C09C 1/48; C01P 2004/45; C01P 2004/51; C01P 2004/64

(57) ABSTRACT

A carbon black with good dispersibility is provided. The carbon black has a full width at half maximum (FWHM) of greater than 0 and less than or equal to 0.3 μm as measured by a centrifugal sedimentation method, wherein the centrifugal sedimentation method uses anhydrous ethanol as a solvent.

### FIELD

This application priority under 35 U.S.C. § 119 to Taiwanese Patent Application No. 112132586, filed Aug. 29, 2023, the entireties of which are incorporated by reference herein.

The present disclosure relates to a carbon black and, in particular, to a carbon black suitable for use in coatings.

### BACKGROUND

Carbon black is a kind of amorphous carbon, which is widely used as a colorant or filler in industry. When used as a colorant, it can provide a black or darker effect to inks or paints. When used as a filler, it can improve the mechanical strength of rubber products. Because carbon black can not only impart color to products, but also enhance the mechanical properties of products, it is widely used in various fields.

However, in practical applications, the content of carbon black in the product is usually not very high, because once it exceeds a critical value, the mechanical strength of the product will decrease. Therefore, the industry generally hopes that the blackness of carbon black should be as high as possible, so that a smaller amount of carbon black can be used to achieve the desired blackness of the product.

### SUMMARY

In view of the above problems, an object of the present disclosure is to provide a carbon black that can be added to a product to impart high blackness to the product.

In order to achieve the above purpose, the present disclosure provides a carbon black having a full width at half maximum (FWHM) of greater than 0 and less than or equal to 0.3 μm as measured by a centrifugal sedimentation method, wherein the centrifugal sedimentation method uses anhydrous ethanol as a solvent.

Preferably, the full width at half maximum is greater than 0 and less than or equal to 0.2 μm. More preferably, the full width at half maximum is greater than 0 and less than or equal to 0.17 μm.

Preferably, the carbon black has a mode particle size of greater than 0 and less than or equal to 0.4 μm as measured by the centrifugal sedimentation method, wherein the centrifugal sedimentation method uses anhydrous ethanol as the solvent. More preferably, the mode particle size is greater than 0 and less than or equal to 0.3 μm.

Preferably, a primary particle size of 10 to 80 nm.

Preferably, the carbon black has an aggregate with a particle size of 100 to 600 nm.

Preferably, the carbon black has a volatile content of 2 wt % to 10 wt %.

Preferably, the carbon black has a tinting strength of 90% to 128%.

The present disclosure also provides a use of the carbon black described above, wherein the carbon black is used for a coating.

Preferably, the coating is an ink, a metallic paint or a color paste.

The carbon black of the present disclosure has good dispersibility, and when added to a product, it can impart high blackness to the product.

### BRIEF DESCRIPTION OF THE DRAWINGS

FIG. 1A, FIG. 1B and FIG. 1C show the particle size distribution curves of the carbon black of Production Example 1, Production Example 2 and Comparative Example 1, respectively.

### DETAILED DESCRIPTION OF THE PRESENT EMBODIMENTS

The “full width at half maximum (FWHM)” referred to in the present disclosure refers to the width of the particle size distribution curve at half maximum height.

The “mode particle size (D_{mode})” referred to in the present disclosure refers to the diameter determined by the maximum peak of the particle size distribution curve.

In the present disclosure, “particle size distribution curve” is obtained by the centrifugal sedimentation method, wherein the centrifugal sedimentation method uses anhydrous ethanol as the solvent.

In the present disclosure, “between X and Y” is equivalent to “X˜Y”, and includes the end values X and Y.

The carbon black provided by the present disclosure has a full width at half maximum (FWHM) of greater than 0 and less than or equal to 0.3 μm as measured by a centrifugal sedimentation method. In some embodiments, the full width at half maximum is between any two of the following values: 0.3, 0.27, 0.25, 0.23, 0.21, 0.2, 0.19, 0.17, 0.16, 0.13, 0.1, 0.07, 0.05, 0.03 and 0.01 μm. In some embodiments, the full width at half maximum is greater than 0 and less than or equal to 0.2 μm. In some embodiments, the full width at half maximum is greater than 0 and less than or equal to 0.17 μm.

The mode particle size of the carbon black measured by the centrifugal sedimentation method can be greater than 0 and less than or equal to 0.4 μm. In some embodiments, the mode particle size is between any two of the following values: 0.4, 0.37, 0.35, 0.33, 0.31, 0.29, 0.28, 0.27, 0.26, 0.25, 0.24, 0.23, 0.22, 0.21, 0.17, 0.15, 0.13, 0.1, 0.08, 0.06, 0.049, 0.04, 0.288, 0.02 and 0.01 μm. In some embodiments, the mode particle size is greater than 0 and less than or equal to 0.3 μm. In some embodiments, the mode particle size is greater than 0 and less than or equal to 0.2 μm.

In some embodiments, the primary particle size of the carbon black is 10 to 80 nm. In some embodiments, the primary particle size of the carbon black is between any two of the following values: 15, 20, 25, 30, 35, 40, 45, 50, 55, 60, 65, 70 and 75 nm. In some embodiments, the particle size of the aggregate of the carbon black is 100 to 600 nm. In some embodiments, the particle size of the aggregate of the carbon black is between any two of the following values: 125, 150, 175, 200, 225, 250, 275, 300, 325, 350, 375, 400, 425, 450, 475, 500, 525, 550 and 575 nm.

The carbon black may have a volatile content of 2% to 10% by weight. In some embodiments, the volatile content is between any two of the following values: 2.2 wt %, 2.4 wt %, 2.6 wt %, 2.8 wt %, 3.5 wt %, 4.0 wt %, 4.5 wt %, 5 wt %, 5.5% wt %, 6 wt %, 6.5 wt %, 7wt %, 7.5 wt %, 8 wt %, 8.5 wt %, 9 wt % and 9.5 wt %.

In the present disclosure, the carbon black can have a tinting strength of 90% to 128%. In some embodiments, the tinting strength is between any two of the following values: 91%, 95%, 97%, 100%, 102%, 107%, 110%, 112%, 115%, 117%, 120%, 123%, 125% and 127%.

The present disclosure also provides a use of the carbon black mentioned above, which is used in coatings. The coatings include, but are not limited to, inks, metallic paints or color paste. The color paste can be polyurethane (PU) color paste.

### Production Example: Production of Carbon Black

The carbon black of Production Examples 1 and 2 are manufactured by modifying the JE4205 carbon black of International China Rubber using the carbon material post-modification treatment system disclosed in Taiwan Patent No. 1796678B. The production conditions are as shown in Table 1. The content of Taiwan Patent No. 1796678B is incorporated herein by reference in its entirety.

TABLE 1

| | Carbon | | | | | |
|---|---|---|---|---|---|---|
| | black | | Rotation | | | |
| | feeding | | speed of | | Ozone | Reaction |
| Production | amount per | Quantitative | reactor | Ozone flow | concentration | time |
| Example | batch | pacer (%) | screw (%) | rate (L/min) | (g/m³) | (min) |
| 1 | 7~10 Kg | 18~30 | 50~70 | 40/40 | 50~200 | 100~120 |
| 2 | 7~10 Kg | 18~30 | 50~70 | 40/40 | 50~200 | 320~340 |

Table 2 shows the nitrogen adsorption specific surface area (NSA), oil absorption number (OAN), tinting strength (Tint) and volatile content of the carbon black of Production Example 1, Production Example 2 and Comparative Example 1. The carbon black of Comparative Example 1 in Table 2 refers to unmodified JE4205 carbon black. The measurement items listed in Table 2 are carried out in the following manner:

### NSA

The carbon black specific surface area is measured according to ASTM D6556. The gas pressure of gas adsorbed and desorbed on the surface and pores of carbon black at a constant temperature is measured using the nitrogen surface area as the total surface area of the outer surface area and inner surface area according to the BET theoretical formula. The specific surface area is calculated using the gas molecule cross-sectional area, the gas molecule volume and the sample weight.

$$\frac{P}{{V}_{a} ( {P}_{0} - P )} = \frac{1}{{V}_{m} C} + \frac{C - 1}{{V}_{m} C} \times \frac{P}{{P}_{0}}$$

P is the pressure, P0 is the saturation pressure, Va is the total absorption volume, C is the BET constant, and Vm is the gas volume required to form a single layer.

### OAN (Oil Absorption Number)

Carbon black OAN is measured according to ASTM D2414. The quantitative carbon black is weighed and titrated to the end point using white mineral oil with a density of 1.042 to 1.047 g/cm³. The absorption value is calculated based on the weight and the titration amount of the carbon black sample, and substituted into the following formula to obtain the OAN value.

$$D = \frac{V}{M} \times 100$$

D: White mineral oil (petroleum) absorption value of soot, V: Volume of consumed white mineral oil (petroleum), M: Sample weight.

### Tinting Strength

The tinting strength of carbon black is measured according to ASTM D3265. After a certain amount of carbon black, zinc oxide, and epoxidized soybean oil are weighed and then grinded and dispersed, a film puller is used to pull out an ink paste film with a length of 7 mm and a width of 4 mm. A black meter is used to measure the reflectivity of the ink paste. The tinting strength is calculated according to the following formula. T in the following formula represents the tinting strength.

$$T ( \% ) = \frac{Standard soot ref1ectivity}{Soot pattern ref1ectivity} \times 100 \%$$

### Volatile Content

The organic compounds released by baking carbon black at 950° C. for 7 minutes, including residual oil, adhesives, and surface functional groups, are measured and may be obtained by measuring the weight of the crucible before and after the carbon black is burned and calculating the loss percentage.

TABLE 2

| | Production | Production | Comparative |
|---|---|---|---|
| | Example 1 | Example 2 | Example 1 |
| NSA (m²/g) | 125 | 125 | 125 |
| OAN (mL/100 g) | 65 | 72 | 60 |
| Tinting strength (%) | 120 | 101 | 130 |
| Volatile content (%) | 2.5 | 5.0 | Less than 1 |

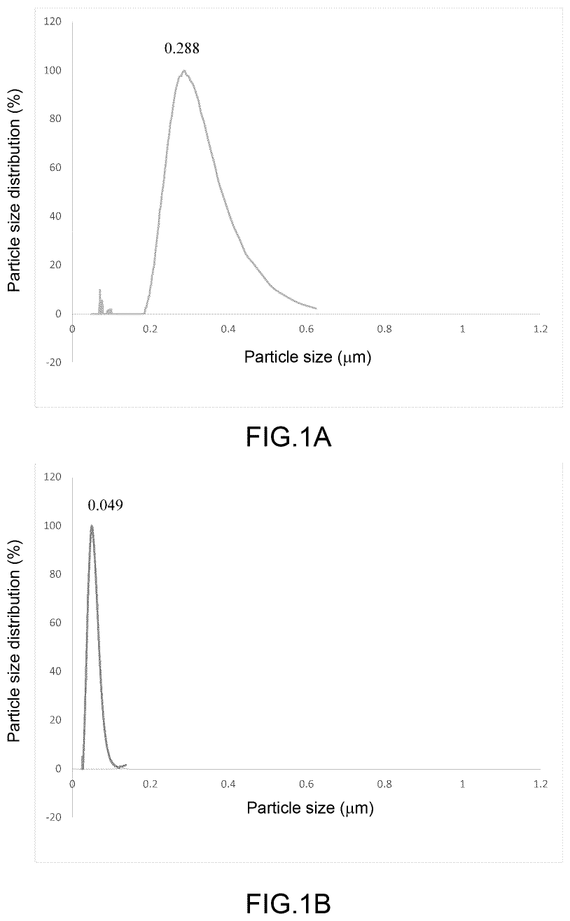

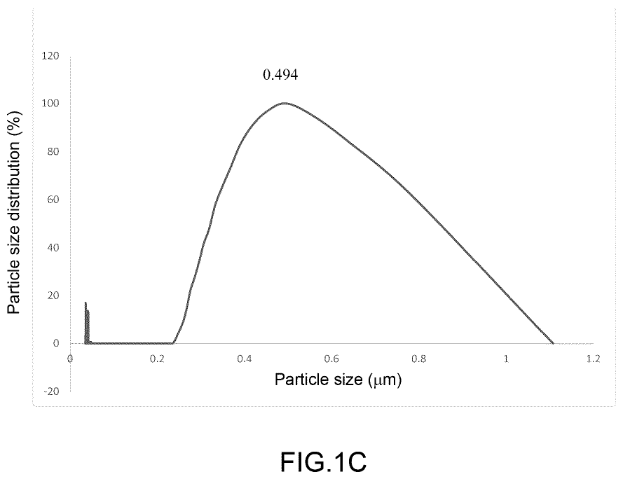

FIG. 1A, FIG. 1B and FIG. 1C show the particle size distribution curves of the carbon black of Production Example 1, Production Example 2 and Comparative Example 1, respectively. The aggregate particle size distribution curve is measured by the centrifugal sedimentation method using anhydrous ethanol as the solvent without using any dispersant. The particle size distribution curve is measured using a Brookhaven BI-DCP disc centrifuge, equipped with the red light diode, and the distribution curve of the aggregates of dispersed solids is determined based on the absorption value measurement. Detailed measurement methods are described below.

2 g of carbon black and 25 ml of anhydrous ethanol are placed in a 50 ml beaker. The beaker containing the carbon black slurry is placed in the ultrasonic oscillation water tank and shaken for 1 minute for pre-dispersion. Next, the probe oscillator is put into the slurry with ice cube cooling outside the beaker and the dispersion is carried out under ultrasonic vibration (70% pulse) for 5 minutes to obtain the carbon black dispersion liquid.

Before starting the measurement, the centrifuge is operated at 8000 rpm for 10 minutes. Next, 1 ml of anhydrous ethanol and 15 ml of deionized water are sequentially injected as the spin solution, and 200 μl of n-dodecane is used to cover the spin solution in the centrifuge. Next, 0.2 ml of the dispersion liquid is injected into the turntable with the spin solution to start the measurement program, and the original data is used for the instrument's calculation process under astigmatism correction and automatic baseline correction to obtain the results of FIG. 1A, FIG. 1B, FIG. 1C and Table 3.

TABLE 3

| | Production | Production | Comparative |
|---|---|---|---|
| | Example 1 | Example 2 | Example 1 |
| mode particle | 0.288 | 0.049 | 0.494 |
| size (μm) | | | |
| FWHM (μm) | 0.153 | 0.031 | 0.52 |

### EXAMPLES

### Production of Metallic Paint

The ingredients listed in Table 4 are mixed in proportion, and the carbon black is the carbon black of Production Example 1, Production Example 2 or Comparative Example 1. After mixing, a high-speed mixer is used to mix evenly, and the resulting slurry is added to a horizontal bead mill for grinding for 50 minutes. After grinding, a fineness meter is used to determine the fineness until the fineness is less than 10 μm. Next, a solvent is added to adjust the viscosity to the same range (i.e., the viscosity is FC #4 60±10 seconds), thereby obtaining the metallic paints of Example 1, Example 2 and Comparative Example 2.

TABLE 4

| Metallic paint components | Parts by weight |
|---|---|
| A136-70 purchased from Dali Polymer | 114 |
| Co., Ltd. (solid content 70%) | |
| Melamine MR625 purchased from | 20 |
| Changchun Chemical as a cross- | |
| linking agent (solid content 76%) | |
| BYK-118 (solid content 80%) | 1.5 |
| Carbon black | 15 |
| BYK057 (solid content 40%) | 0.5 |
| Korea CKB POLYFLOW No. 90 | 3 |
| Thinner | 45 |

<Note>In the above table, BCS/Xylene/#150=40/40/20 is used as the diluent, where #150 refers to paint solvent-150 (High-Flash Aromatic Naphtha-150); and BYK-118, BYK057 and POLYFLOW No. 90 are used as additives.

The metallic paints of Example 1, Example 2 and Comparative Example 2 are coated on the tinplate with a wire bar, and baked at 130° C. for 30 minutes. Next, the gloss is measured with a gloss meter (Dr Lange REFO3), and the blackness and hue are measured with a colorimeter (X-rite Ci7600). When measuring the blackness and hue, SCE* (specular light removal) mode is used to eliminate specular reflection light and truly represent the colors seen by the human eye. The test results are shown in Table 5.

TABLE 5

| | | | | Comparative |
|---|---|---|---|---|
| Evaluation test results | | Example 1 | Example 2 | Example 1 |
| Specular light | L* | 5.89 | 4.15 | 10.34 |
| removal | | | | |
| Specular light | b* | −0.68 | −1.07 | −1.89 |
| removal | | | | |

| | | | |
|---|---|---|---|
| Gloss 20° | 58.63 | 65.2 | 49.55 |
| Gloss 60° | 83.75 | 89.93 | 83.37 |

As shown in Table 5, the metallic paint added with the (modified) carbon black of the present disclosure exhibits excellent blackness (i.e., L* is significantly lower) and has higher gloss. It is worth noting that, as shown in Table 2, although the carbon black of Production Examples 1 and 2 has a certain degree of blackness, the blackness is significantly lower than that of the carbon black of Comparative Example 1 (i.e., the tinting strength is significantly lower than that of the carbon of Comparative Example 1). However, in the experimental results of Table 5, the metallic paint prepared using the carbon black of Production Example 1 or 2 has a higher blackness than the metallic paint prepared using Comparative Example 1. This result proves that the carbon black of Production Example 1 or 2 has extremely excellent dispersibility in metallic paint. Therefore, the essence of carbon black can be well presented in metallic paint, allowing the metallic paint to have excellent blackness.

### Production of PU Color Paste

The ingredients listed in Table 6 are mixed in proportion, wherein the PU color paste precursors of Example 3 and Example 4 are prepared by using the carbon black of Production Example 1 and Production Example 2 respectively.

TABLE 6

| Items | Weight (g) |
|---|---|
| Polyester polyol | 66 |
| Carbon black | 33 |
| Dispersant (BYK-9076) | 1 |
| Total weight | 100 |

18 g of #150 solvent is added into the PU color paste precursors of Example 3 and Example 4 and stirred for 10 minutes. The viscosity (centipoises, cps) and Torque % value are measured with a BROOKFIELD instrument. The results are shown in Table 7.

TABLE 7

| | Example 3 | Example 4 |
|---|---|---|
| Viscosity | 404700 cps | 228700 cps |
| | (Torque: 60.7%) | (Torque: 34.3%) |

From the results in Table 7, it can be seen that the PU color paste precursors of Example 3 and Example 4 have good fluidity, which means that the carbon black of Production Example 1 and Production Example 2 can be well dispersed in the PU color paste.

In summary, it can be seen that the carbon black of the present disclosure can not only impart higher gloss to the coating, but also can impart excellent blackness to the coating, and the carbon black of the present disclosure has good dispersibility and has good dispersion performance in the coating.

However, the above are only preferred embodiments of the present disclosure, which cannot be used to limit the implementation scope of the present disclosure, that is, all the simple equivalent changes and modifications made based on the claims and specification of the present disclosure fall within the scope of the claimed invention.

What is claimed is:

1. A carbon black, having a full width at half maximum (FWHM) of greater than 0 and less than or equal to 0.3 μm as measured by a centrifugal sedimentation method, wherein the centrifugal sedimentation method uses anhydrous ethanol as a solvent.

2. The carbon black of claim 1, wherein the full width at half maximum is greater than 0 and less than or equal to 0.2 μm.

3. The carbon black of claim 2, wherein the full width at half maximum is greater than 0 and less than or equal to 0.17 μm.

4. The carbon black of claim 1, having a mode particle size (D_{mode}) of greater than 0 and less than or equal to 0.4 μm as measured by the centrifugal sedimentation method, wherein the centrifugal sedimentation method uses anhydrous ethanol as the solvent.

5. The carbon black of claim 4, wherein the mode particle size is greater than 0 and less than or equal to 0.3 μm.

6. The carbon black of claim 1, having a primary particle size of 10 to 80 nm.

7. The carbon black of claim 1, having an aggregate with a particle size of 100 to 600 nm.

8. The carbon black of claim 1, having a volatile content of 2 wt % to 10 wt %.

9. The carbon black of claim 1, having a tinting strength of 90% to 128%.

10. A use of the carbon black of claim 1, wherein the carbon black is used for a coating.

11. The use of claim 10, wherein the coating is an ink, a metallic paint or a color paste.
